(19) United States
(12) Patent Application Publication
(10) Pub. No.: US 2023/0241710 A1
(43) Pub. Date: Aug. 3, 2023

(54) Method for Analyzing a Workpiece Surface for a Laser Machining Process and Analysis Device for Analyzing a Workpiece Surface

(71) Applicant: PRECITEC GMBH & CO. KG, Gaggemai (DE)

(72) Inventor: Schwarz Joachim, Kleinandelfingen (CH)

(21) Appl. No.: 18/023,969

(22) PCT Filed: Sep. 2, 2021
(86) PCT No.: PCT/EP2021/074208

§ 371 Date: Feb. 28, 2023

(30) Foreign Application Priority Data
Sep. 2, 2020 (DE) 10 2020 122 924.0

(51) Int. Cl. B23K 26/03; B23K 26/044; B23K 31/12

(52) U.S. Cl. CPC B23K 26/032; B23K 26/044; B23K 31/125

(57) ABSTRACT

A method for analyzing a workpiece surface for a laser machining process includes radiating a light line of light of a first wavelength range into a workpiece surface area and illuminating the area with light of at least one second wavelength range. Further, capturing an image of the workpiece surface area by a sensor device including an image sensor and imaging optics, the optics having different refractive indices for the first and second wavelength ranges. A first plane is defined by the light line and a light exit point. The optics and image sensor are arranged in a Scheimpflug arrangement. Further, evaluating the image to analyze workpiece surface features based on a predetermined offset between the first plane and a second plane for which the light of the second wavelength range from the optics is sharply imaged on the image sensor sensor plane. An analysis device carries out the method.

### CROSS-REFERENCE TO RELATED APPLICATIONS

This application is the U.S. National Stage of PCT/EP2021/074208 filed on Sep. 2, 2021, which claims priority to German Patent Application 102020122924.0 filed on Sep. 2, 2020, the entire content of both are incorporated herein by reference in their entirety.

### FIELD OF THE INVENTION

The present invention relates to a method for analyzing a workpiece surface for a laser machining process and an analysis device for analyzing a workpiece surface. The present invention also relates to a method for machining a workpiece using a laser beam, which includes such a method, and a laser machining head including such an analysis device.

### BACKGROUND OF THE INVENTION

In a laser machining system for machining a workpiece using a laser beam, the laser beam emerging from a laser light source or from one end of a laser optical fiber is focused or collimated onto the workpiece to be machined with the aid of beam guiding and focusing optics. Machining may comprise methods for joining workpieces, for example laser welding or laser soldering. The laser machining system may comprise a laser machining device, for example a laser machining head, in particular a laser welding head. For quality assurance and control, it is necessary to monitor the laser machining process.

Current solutions for monitoring laser machining processes comprise “pre-process”, “in-process” and “post-process” monitoring processes or systems. During joining, the pre-process monitoring has the object of detecting a joining spot, in particular a joining gap, in order to guide the laser beam to the appropriate position or to determine an offset of the joining partners. In-process and post-process monitoring are typically used to monitor the laser machining process and to ensure the quality of the resulting joint. In particular, post-process monitoring, also known as “post-process inspection”, is used for quality monitoring since it can be used to inspect the resulting weld seam and measure it using current standards (e.g. “SEL100”). The variables of features to be measured are typically an edge misalignment, a connection cross-section as well as a concavity or convexity and a bottom camber or top camber of the weld seam. The coating of high-strength steels and the removal of the coating necessary before welding leads to the additional requirement of a coating or removal measurement when monitoring the laser machining process.

For these tasks, nowadays 3D methods are used to detect a three-dimensional height profile of a workpiece surface, also called “geometry”. Laser triangulation methods or laser light section methods and devices, in particular Scheimpflug sensors, are typically used for this purpose. A fan-shaped light beam, i.e. spread out in only one plane, is radiated onto the workpiece surface in order to generate a light line there. An image of the light line is captured by an image sensor at an angle to the direction of radiation. The captured image is then evaluated in order to detect a position and/or shape of the light line in the image. Based thereon, conclusions about the geometry of the workpiece surface can be drawn.

Furthermore, 2D methods are used, wherein images, in particular gray images, of the workpiece surface are captured and a surface analysis is carried out by means of image processing. This can improve the detection of the weld seam and other features of the workpiece surface. For example, irregularities in the weld seam surface and small pores can be detected and the weld seam can thus be reliably distinguished or segmented from the unmachined workpiece surface. In practice, capturing an image of the workpiece surface in parallel to or at the same time as the laser light section method is made more difficult by the following circumstances.

On the one hand, recording an image with an image sensor oriented in parallel to the workpiece surface, i.e. with an image parallel to the workpiece surface, has the disadvantage of a very small depth of focus in a direction perpendicular to the workpiece surface. This leads to a high level of effort for evaluation and alignment of the image sensor and requires, for example, a high-precision clamping device for parallel imaging with additional illumination.

On the other hand, a gray image generated based on the intensity of the laser line reflected from the workpiece surface by an image sensor used for the laser light section method, as described for example in DE 10 2011 012 729 A1, often only provides low-contrast gray images of the workpiece surface since the maximum intensity of the laser line is usually in the saturation range of the image sensor. Likewise, generating a gray image based on the scattered light of the laser line has the disadvantage that little contrast is obtained. In addition, the typical “speckle” effect of the laser line leads to an inhomogeneous illumination of the workpiece surface. Additional illumination of the workpiece surface cannot eliminate this disadvantage since the depth of focus in a plane parallel to the workpiece surface is very small and additionally restricted by the fact that the bright laser line is in this region. A combination of the laser light section method with additional illumination and parallel imaging, as described in EP 1 448 334 A1, therefore only leads to a small depth of focus.

### SUMMARY OF THE INVENTION

It is an object of the invention to provide a method allowing for both detecting a three-dimensional height profile of the workpiece surface and capturing a two-dimensional image of the workpiece surface. It is also an object of the invention to provide a method allowing for capturing a two-dimensional image, in particular a gray image, of a workpiece surface with a large depth of focus in parallel or simultaneously to a light section method for three-dimensional data acquisition.

It is also an object of the invention to provide a method with which a contrast and a depth of field are improved when recording an image of a workpiece surface, in particular parallel or simultaneously to a light section method. Furthermore, it is an object of the invention to provide a method with which a high profile scan rate can be achieved when reading out the image sensor.

Finally, it is an object of the invention to provide a device configured to carry out the method.

The objects described above are achieved by the subject matter disclosed herein. Advantageous refinements and developments are also disclosed.

The invention is based on the idea of using a sensor device including an image sensor and optics for the three-dimensional detection of a workpiece surface by means of a light section or light section triangulation method, said optics having different refractive indices for light in a first wavelength range and light in a second wavelength range. As a result, the optics has different focal planes for the two wavelength ranges which are imaged sharply on a sensor plane of the image sensor by the optics in a Scheimpflug arrangement. This property of the optics can be used to capture a sharp image of a partial area of the workpiece surface, which is spaced apart from the light line, in parallel to capturing a sharp image of a light line reflected from the workpiece surface for carrying out the light section method. Using the present invention, the partial area of the workpiece surface that is imaged sharply for light in the second wavelength range is spatially separated from the light line imaged sharply in the first wavelength range on the sensor plane. Accordingly, the sensor device does not have to include any color filters and the same image sensor or the same sensor device can be used to detect a height profile of the workpiece surface and to capture a gray image of the workpiece surface. In addition, a height profile can be created from a first partial area of the workpiece surface and at the same time a gray image can be generated from a second partial area of the workpiece surface. By capturing the image repeatedly, i.e. by sampling or scanning the workpiece surface, and taking into account the known offset, the height profile data and the gray image data may be combined accordingly in order to obtain a three-dimensional height profile and a two-dimensional gray image with a large depth of focus from one and the same area of the workpiece surface. With red illumination, the depth of focus of the generated gray image can be increased from approx. ±0.5 mm to approx. ±5 mm, with a 1:1 image on one inch of the sensor, at which an image area of 10 mm ×10 mm approximately corresponds to the sensor size.

According to a first aspect of the present invention, a method for analyzing a workpiece surface for a laser machining process is provided. The method comprises the steps of: radiating a light line of light of a first wavelength range into an area of the workpiece surface and illuminating the area of the workpiece surface with light of at least one second wavelength range; capturing an image of the area of the workpiece surface by means of a sensor device comprising an image sensor and optics for imaging on the image sensor, wherein the optics have different refractive indices for the first and second wavelength ranges and wherein the image sensor (or a sensor plane of the image sensor), the optics and a first plane, which is defined by the light line and a light exit point of the light of the first wavelength range, are arranged in a Scheimpflug arrangement, and evaluating the image to analyze features of the workpiece surface based on a predetermined offset between the first plane and a second plane, for which the light of the second wavelength range is imaged by the optics, in particular sharply or in a focused manner, on the image sensor (or on the sensor plane of the image sensor).

In other words, a method according to the first aspect comprises the steps of: radiating a planar fan-shaped light beam of light of a first wavelength range to generate a light line in an area of the workpiece surface and illuminating the area of the workpiece surface with light of a second wavelength range; capturing an image of the area of the workpiece surface by means of a sensor device comprising an image sensor and optics for imaging light on the image sensor, wherein the optics have different refractive indices for the first and second wavelength ranges, and wherein a first plane defined by the plane of the fan-shaped light beam, the optics and the image sensor are arranged in a Scheimpflug arrangement; and evaluating the image to analyze features of the workpiece surface based on a predetermined offset on the workpiece surface between the first plane and a second plane for which the light of the second wavelength range is imaged on the image sensor by the optics.

The first plane, the optics and the image sensor or a sensor plane of the image sensor are arranged in a Scheimpflug arrangement and thus meet the Scheimpflug condition. In other words, the first plane, a plane perpendicular to the optical axis through the optics and the sensor plane of the image sensor have a common line of intersection. Accordingly, the second plane, the optics and the sensor plane of the image sensor may likewise be arranged in a Scheimpflug arrangement.

The first wavelength range and the second wavelength range are preferably different and/or spaced apart from one another. The two wavelength ranges are preferably so different that a sufficient offset can be ensured. The first wavelength range and the second wavelength range may be relatively narrow wavelength ranges, for example the wavelength ranges may be less than 50 or even less than 30 nm wide. A distance between the first and second wavelength ranges may be 100 nm or more. Light of the first wavelength range may include or be blue light, preferably light with a wavelength in a wavelength range from 400 nm to 500 nm, in particular light with a wavelength of 450 nm. Light of the second wavelength range may include or be red light, preferably light with a wavelength in a wavelength range from 600 nm to 700 nm, in particular light with a wavelength of 660 nm. The image sensor is preferably sensitive to both wavelength ranges.

Radiating a light line of light of a first wavelength range may include radiating a planar fan-shaped light beam to generate the light line on the workpiece surface. The first plane may correspond to a plane of the fan-shaped light beam. In other words, the first plane may be defined by the light line and a light exit point of the light of the first wavelength range (in particular a light exit point of the light from an illumination unit). The first plane may correspond to a focal plane of the optics for the first wavelength range or a plane for which the light of the first wavelength range is imaged by the optics (sharply or in a focused manner) on the image sensor or on the sensor plane of the image sensor. The first plane is preferably arranged perpendicularly to the workpiece surface. The first plane may include the light line for a light section or triangulation method. The first plane may therefore also be referred to as the “triangulation plane”. The second plane may correspond to a focal plane of the optics for the second wavelength range.

The first and/or the second plane may intersect the workpiece surface. The first plane may intersect the workpiece surface in a first cutting line. The second plane can intersect the workpiece surface in a second line of intersection. The first and second lines of intersection are spaced apart from each other. The distance between the two lines of intersection may also be referred to as an offset.

In addition, there is a certain depth of focus range within which points are imaged sufficiently sharply for the subsequent image evaluation on the image sensor by the optics for light in the first wavelength range or for light in the second wavelength range. Accordingly, a first partial area of the workpiece surface, which surrounds a line of intersection of the first plane with the workpiece surface, and a second partial area of the workpiece surface, which surrounds the line of intersection of the second plane with the workpiece surface, are imaged sharply on the image sensor. The first partial area may include or correspond to the depth of focus range of the optics for light of the first wavelength. The second partial area may include or correspond to the described depth of focus range of the optics for light of the second wavelength. The area of the workpiece surface surrounding the first line of intersection may also be referred to as the first sharp or partial area. Correspondingly, the area of the workpiece surface surrounding the second line of intersection may also be referred to as the second sharp or partial area. The offset is preferably chosen such that the two partial areas are spaced apart from one another. Based on the offset and a predetermined or known depth of focus of the optics for light in the first wavelength range or for light in the second wavelength range, the distance between the first partial area and the second partial area of the workpiece surface can be specified. Accordingly, the light line of the first wavelength range is not in the second partial area, which is imaged sharply for light of the second wavelength range. Since the light line, e.g. a laser light line, is not in the second partial area, the capture of the image of the workpiece surface in this area is not disturbed by the bright light line. As a result, a contrast of the captured image in the second partial area is not disturbed by an intensity of the light line. A contrast in the captured image for the second partial area of the workpiece surface can thus be increased. Thus, the present invention makes it possible to use the advantage of a large measuring range of the Scheimpflug arrangement for capturing an image.

The given offset may be a predetermined or known offset. The offset may depend on the optics, in particular on the respective refractive indices of the optics for the first and second wavelength ranges, the first and second wavelength ranges and/or the arrangement of the optics relative to the workpiece surface. The arrangement of the optics may indicate a distance and/or an orientation of the optics relative to the workpiece surface. The offset may be modeled, calculated or determined by a calibration measurement. The offset may be specified with respect to the workpiece surface, e.g. as a distance between the first and second lines of intersection, or along an optical axis of the optics.

In addition to light of a second wavelength range for generating the second partial area on the workpiece surface, the method may be extended in such a way that at least one additional, i.e. a third, wavelength range is used for illumination, the image of which causes a focal distance shift which lies within the depth of focus of the second wavelength range. In this way, the surface that is sharply imaged can be enlarged. Preferably, at least one further illumination unit configured to illuminate the workpiece surface with light of a third wavelength range is provided. Alternatively, the illumination unit may be configured to illuminate the workpiece surface with light in the second wavelength range and a third wavelength range. Central wavelengths of the second wavelength range and the third wavelength range are preferably spaced apart from one another or offset from one another. The wavelength ranges used for the illumination, i.e. in particular the second wavelength range and the third wavelength range, preferably do not overlap, but rather adjoin one another or are spaced apart from one another. By illuminating with light of the third wavelength range, a third plane, for which the light of the third wavelength range is imaged by the optics on the image sensor, or a third partial area on the workpiece surface, which surrounds a line of intersection of the third plane with the workpiece surface, may be generated. The optics preferably has different refractive indices for each of the wavelength ranges used for illumination, i.e. in particular for the second wavelength range and the third wavelength range. When evaluating the image, a predetermined offset on the workpiece surface between the first plane and the third plane may also be taken into account. Evaluating the image may also comprise evaluating intensity data of light of the third wavelength range in an area of the image corresponding to the third partial area in order to obtain a gray image of the third partial area. This may apply to any number of wavelength ranges used for illumination. In particular, the plurality of wavelength ranges used for illumination may be chosen such that the corresponding partial areas on the workpiece surface adjoin one another. In other words, the plurality of wavelength ranges used for the illumination may be chosen such that the offset of the focal distance corresponds to the depth of focus range when the imaging is sharp. Then the sharply imaged workpiece surfaces of the different wavelengths adjoin one another. Preferably, the illumination unit has a continuous spectrum from which the first wavelength range has been removed, e.g., by a filter. Using a continuous spectrum of the illumination unit while cutting off the first wavelength range with a filter, for example with an edge filter or a notch filter, a continuous area of the surface can be imaged sharply. This range is limited by the depth of focus of the optics, regardless of the chromatic aberration.

The area around the laser line can therefore be imaged sharply within the depth of focus, regardless of the depth of the workpiece. Planes generated by illumination with wavelength ranges shifted from one another and offset to the laser line wavelength (i.e. to the first wavelength range) can also be imaged sharply due to the chromatic aberration of the optics. A workpiece surface imaged sharply can thus be enlarged.

The sensor plane of the image sensor may include a sensor surface of the image sensor onto which light is radiated in order to capture an image.

The image may be captured based on light reflected from the workpiece surface. The captured image may be or include a color image, a brightness image, and/or an intensity image.

Evaluating the captured image may comprise evaluating the light intensity in the first wavelength range, for example using a triangulation method or light section method, to generate a (preferably three-dimensional) height profile of the workpiece surface and/or evaluating the light intensity in the second wavelength range, for example using image analysis or image processing, to generate a two-dimensional gray image. Evaluating the image may comprise evaluating the image row by row and/or column by column.

Evaluating the image may comprise evaluating brightness or intensity information contained in the image about light of the first wavelength range which was reflected by the workpiece surface. Evaluating the image may comprise detecting a position and orientation of the light line depicted in the image. Based thereon, the triangulation or light section method may be carried out in order to detect, for example, the position, orientation, height and/or extension of features of the workpiece surface, for example a joint edge, a joint gap or a weld seam.

Evaluating the image may comprise evaluating brightness or intensity information contained in the image about light of the second wavelength range, which was reflected from an area surrounding the second line of intersection, also called second sharp area or partial area, of the workpiece surface.

The offset, i.e. for example the distance between the line of intersection of the first plane with the workpiece surface and the line of intersection of the second plane with the workpiece surface, is predetermined or known. It is thus also known at which position and in which orientation the second partial area of the workpiece surface is depicted in the image. The captured image may therefore be evaluated with regard to the second partial area. In other words, brightness information for light in the second wavelength range may be extracted for the imaged second partial area. Based thereon, a (sharp) gray value image of the second partial area can be obtained. Thus, an evaluation of the first partial area based on the light line (e.g. based on a shape of the captured light line) and an evaluation of the second partial area based on an intensity distribution captured in the second partial area may be evaluated independently or separately from one another.

The evaluation of the captured image is used to analyze features of the workpiece surface. The features of the workpiece surface to be analyzed may include at least one of: a geometry, a height profile, a roughness, a color, reflection properties of the workpiece surface, a joint edge, an edge offset or a joint gap between two workpieces, a workpiece step, a weld seam and a cut edge. For example, in the case of laser welding in particular, a weld seam may be analyzed, in particular with regard to its position or orientation on the workpiece surface, reflection properties of the weld seam, a height and/or width of the weld seam, a connection cross-section between welded workpieces, a concavity or convexity of the weld seam and a bottom camber and top camber of the weld seam. For laser cutting, for example, a cut edge may be analyzed, in particular with regard to its position or orientation on the workpiece surface, a roughness or an inclination of the cut edge, etc.

The method for analyzing a workpiece surface for a laser machining process may further comprise the steps of: moving the workpiece relative to the sensor device and repeating the steps described above, radiating the light line of light of a first wavelength range into the area of the workpiece surface, illuminating the area of the workpiece surface with light of a second wavelength range, capturing an image of the area of the workpiece surface, and evaluating the image. In other words, a plurality of images of the workpiece surface may be captured. As a result, a gray image or a height profile can be obtained from a larger area of the workpiece surface. The workpiece is preferably moved in a plane parallel to the workpiece surface and/or perpendicular to an optical axis or to a center line of the incident light of the first wavelength range.

An optical axis of the optics and/or an optical axis of the sensor device may form an acute angle with the first plane. An optical axis of the sensor device and/or the optics may lie in a plane that is perpendicular to the workpiece surface and parallel to a feature of the workpiece surface, e.g., a weld or joint edge. Preferably, the optical axis of the sensor device and/or the optics intersects the feature.

The optics may have a wavelength-dependent refractive index. The optics may in particular be optics that is not corrected with regard to the color error. The optics may include at least one optical element, for example a lens, with such a longitudinal color error. The optics may have a chromatic aberration, i.e. a longitudinal color error, with respect to the first color and/or with respect to the second color. The optics therefore has different refractive indices for the two wavelength ranges. The optics may comprise a lens, a lens group, a focusing lens, a focusing lens group, an objective and/or a zoom lens.

The sensor device may comprise a Scheimpflug sensor or be a Scheimpflug sensor. The image sensor may comprise at least one of: a matrix image sensor, a two-dimensional optical sensor, a camera sensor, a CCD sensor, a CMOS sensor, a photodiode array. The sensor device may be or comprise a CMOS camera.

The area of the workpiece surface may be illuminated with light of a second wavelength range over a large area and/or non-directionally. The illumination unit may comprise a colored LED or an LED that emits in the second wavelength range. The illumination unit may include a broadband light source and a color filter transmissive for light in the second wavelength range.

The light line unit may provide or generate a continuous straight light line. In other words, the light line unit may provide a fan-shaped light beam. The light beam may be radiated perpendicularly onto the workpiece surface. In this case, the first plane may be perpendicular to the workpiece surface. The light line unit for radiating the light line may be a laser device or may comprise a laser device. Alternatively, the light line unit may comprise an optical fiber for radiating the light line. The light beam may be a laser beam or the light line may be a laser light line.

According to a second aspect of the present invention, an analysis device for analyzing a workpiece surface which configured to carry out the method described above is provided. The analysis device comprises: a sensor device including an image sensor for capturing an image and optics for imaging light on the image sensor, the optics having different refractive indices for the first and second wavelength ranges, a light line unit for generating a light line of a first wavelength range, and an illumination unit for generating light of a second wavelength range. The analysis device may further comprise an evaluation unit for evaluating the image captured by the image sensor.

According to a third aspect of the present invention, a method for machining a workpiece by means of a laser beam, in particular laser welding or laser cutting, is provided, said method comprising: radiating a laser beam onto a point on the workpiece surface along a machining path and the method described above for analysis the workpiece surface in advance and/or in the wake of the point along the machining path.

According to a fourth aspect of the present invention, a laser machining head for machining a workpiece, in particular a laser welding head or laser cutting head, by means of a laser beam is provided, said laser machining head including the analysis device described above.

### BRIEF DESCRIPTION OF THE DRAWINGS

The invention is described in detail below with reference to figures.

FIGS. 1 and 2 show schematic views of an analysis device for analyzing a workpiece surface;

FIG. 3 shows, schematically and by way of example, an image captured by the analysis device according to FIGS. 1 and 2;

FIG. 4 shows a schematic view of an image sensor and an optical system for explaining the basic idea of the present invention;

FIG. 5A shows a schematic view of an analysis device for analyzing a workpiece surface according to embodiments of the present invention;

FIG. 5B shows a schematic view of an analysis device for analyzing a workpiece surface according to embodiments of the present invention;

FIG. 6 shows, schematically and by way of example, an image taken by the analysis device according to the present invention;

FIG. 7 shows a block diagram of a method for analyzing a workpiece surface for a laser machining process according to embodiments of the present invention;

FIG. 8 shows a schematic view of a method for machining a workpiece by means of a laser beam, said method including a method for analyzing a workpiece surface according to embodiments; and

FIG. 9 shows a schematic view of an exemplary gray image obtained by a method for analyzing a workpiece surface for a laser machining process according to embodiments of the present invention.

### DETAILED DESCRIPTION OF THE EMBODIMENTS

Unless otherwise noted, the same reference numbers are used below for identical elements and elements with the same effect.

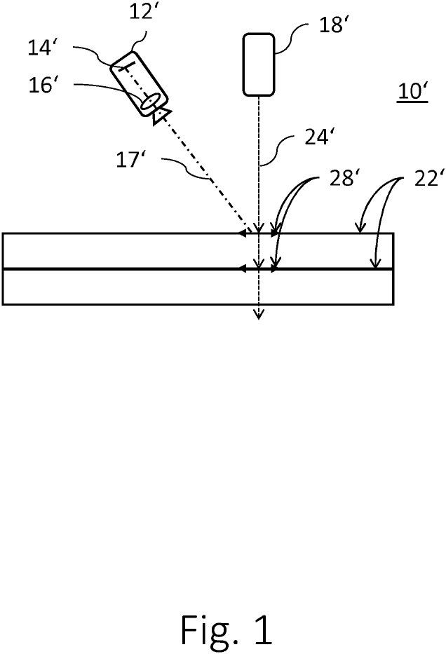

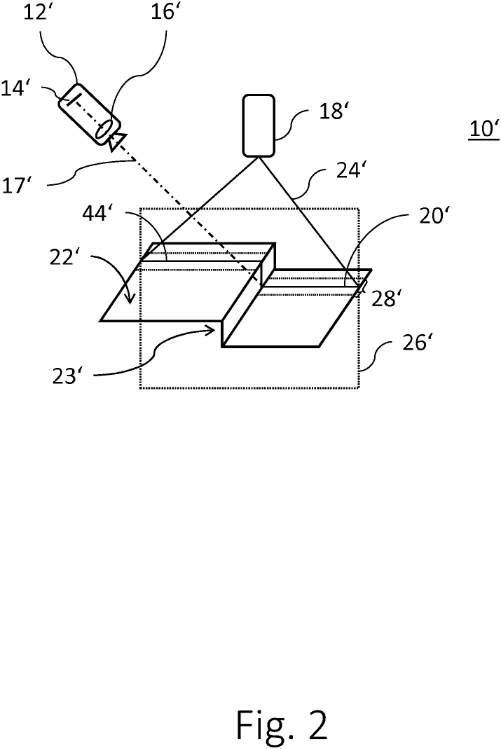

For a better understanding of the invention, FIGS. 1 and 2 show schematic views of an analysis device for analyzing a workpiece surface 22′. FIG. 1 shows a side view of the analysis device and FIG. 2 shows a perspective view of the analysis device. A blue line laser for triangulation, typically 450 nm, is used to generate an object plane (laser triangulation plane) containing the laser lines reflected by the component. This plane is imaged with a Scheimpflug arrangement. The measuring range is defined based on the imaging of the optics.

The analysis device 10′ is configured to carry out a light section method or a light section triangulation method in order to detect a three-dimensional height profile of a workpiece surface 22′. In this way, for example, a joining edge or step 23′ of the workpiece surface 22′ can be detected. The analysis device 10′ may also be referred to as a triangulation sensor.

The analysis device 10′ comprises a sensor device 12′ with an image sensor 14′ for capturing an image and optics 16′ for imaging light on the image sensor 14′. The analysis device 10′ further comprises a light line unit 18′ for generating a light line 20′ on the workpiece surface 22′ and capturing an image of the light line 20′. The light line unit 18′ is configured to radiate a fan-shaped light beam 24′, i.e. spread out in only one plane, onto the workpiece surface 22′ in order to generate the light line 20′ on the workpiece surface 22′. A plane 26′ spanned by the fan-shaped light beam 24′, the optics 16′ and a sensor plane of the image sensor 14′ are arranged in the Scheimpflug arrangement or fulfill the Scheimpflug condition. As a result, the plane 26′ is imaged sharply on the image sensor 14′ by the optics 16′. In other words, all points on the plane 26′ are mapped sharply on the image sensor 14′. Since the plane 26′ also includes the light line 20′, light of the light line 20′ reflected by the workpiece surface 22′ is also sharply imaged on the image sensor 14′. The plane 26′ is typically perpendicular to the workpiece surface 22′ and intersects the workpiece surface 22′. Due to the Scheimpflug arrangement, an line of intersection 44′ of the plane 26′ with the workpiece surface 22′ corresponds to the light line 20′ or coincides with the light line 20′.

In the direction of the optical axis 17′ of the optics 16′, in front of and behind the plane 26′, there is also a certain depth of focus within which points the optics 16′ are imaged sufficiently sharply on the image sensor 14′. In other words, the depth of focus surrounds the first plane 26′. Since the plane 26′ intersects the workpiece surface 22′, all points on planes that intersect the plane 26′ are sharply imaged within the depth of focus. Accordingly, a partial area 28′ of the workpiece surface 22′ which surrounds the line of intersection 44′ of the plane 26′ with the workpiece surface 22′ in the direction of the optical axis 17′ is imaged sharply on the image sensor 14′. In the direction of the optical axis of the optics 16′, the partial area 28′ lies in front of and behind the line of intersection 44′. The partial area 28′ may also be referred to as the “sharp area” since this area of the workpiece surface 22′ is imaged sufficiently sharply for the image evaluation in the captured image.

The plane 26′, for which all points are sharply imaged on the image sensor 14′ due to the Scheimpflug arrangement and the depth of focus of the optics 16′ which surrounds the first plane 26′ in the direction of the optical axis of the optics 16′ may be defined as the measurement range. The measurement range may also be referred to as the “object field”. The first plane 26′ may also be referred to as the “object plane” of the sensor device 12′. If the workpiece surface 22′ intersects the plane 26′, light reflected from the light line 20′ is also sharply imaged on the image sensor 14′. The area of the workpiece surface 22′ that lies within the object field, i.e., the partial area 28′, is also imaged sufficiently sharply on the image sensor 14′.

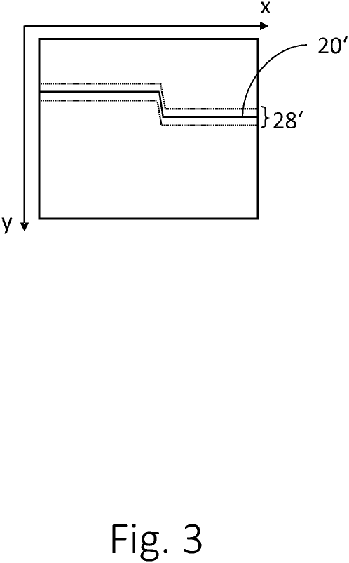

FIG. 3 shows, schematically and by way of example, an image captured by the analysis device. The image comprises a plurality of pixels (not shown) in a matrix arrangement which are arranged in columns along a first direction x and in rows along a second direction y. As shown in FIG. 3, the light line 20′ is imaged on the image captured by the image sensor 14′. In addition, the partial area 28′ of the workpiece surface 22′ which is shown sharply on the image is marked.

Due to the color error of the optics, the image distance, i.e. the position of the measurement range or the object plane, depends on the wavelength. That is, the plane 26′ is imaged differently for different wavelengths in the case of an optics 16′ with color errors. The plane 26′ would be imaged sharply on the image sensor 14′ by the optics 16′, for example for light of a first wavelength range, for example blue light with a wavelength of approx. 450 nm. Due to the color error of the optics 16′, the plane 26′ for light of a second wavelength range, for example red light with a wavelength of approx. 660 nm would not be imaged sharply on the image sensor 14′, however, since the image distance of the optics 16′ is changed for red light. The object distance, i.e. a distance of the optics 16′ to the plane 26′, would have to be changed in order to obtain a sharp image. In other words, the image plane would be at a different distance from a main plane of the uncorrected optics 16′ for each wavelength range.

According to the invention, the color error of the optics is used to separate a sharp area of the workpiece surface for a two-dimensional image, in particular for a gray image, from an image of the light line for the laser triangulation. According to the present invention, a sensor device with an image sensor and an optical system is used for the three-dimensional detection of a workpiece surface using a light section method, said optics having different refractive indices for light in a first wavelength range and light in a second wavelength range. In parallel to capturing a sharp image of a light line reflected from a workpiece surface, a sharp image of a further area of the workpiece surface which is spaced away from the light line may be captured. With the help of the present invention, the area of the workpiece surface that is sharply imaged for light in the second wavelength range is spatially separated from the sharply imaged light line in the first wavelength range in order to combine the advantage of Scheimpflug imaging with a gray image representation with great depth of focus. In this way, the depth of focus, which severely restricted the evaluation range in the gray image, can be extended to the measurement range of the Scheimpflug image.

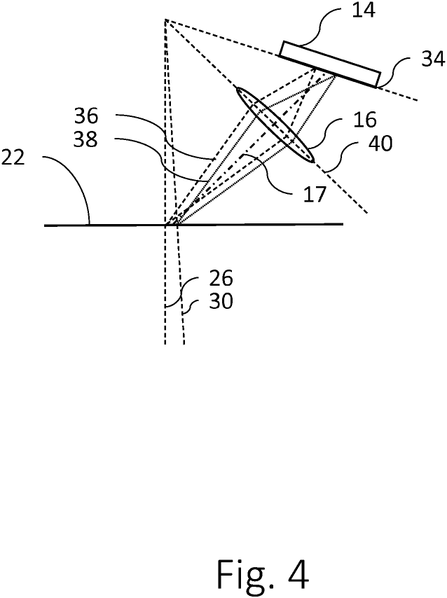

FIG. 4 shows a schematic view of an image sensor and optics of the present invention.

Optics that has a color error, in particular a longitudinal color error or a (longitudinal) chromatic aberration, and thus different refractive indices for light of different wavelengths or wavelength ranges, is also referred to as “uncorrected optics” in the context of this disclosure. The optics may include at least one optical element, for example a lens, with such a color error. The uncorrected optics has different object planes for light of different wavelengths or wavelength ranges. In other words, the optics has different planes for light of different wavelength ranges which are imaged sharply on a predefined image plane, for example a sensor plane of an image sensor, by the optics. For each wavelength range, there is a corresponding object or focal plane which is imaged sharply on this image plane by the optics for light in this wavelength range.

FIG. 4 schematically shows a workpiece surface 22, optics 16 and an image sensor 14 with a sensor plane 34. As shown in FIG. 4, there is a first plane 26 for which light 36 of a first wavelength range is imaged sharply on the sensor plane 34 by the optics 16 and a second plane 30 for which light 38 of a second wavelength range is imaged sharply on the sensor plane 34 by the optics 16. The optics 16, the sensor plane 34 and the first plane 26 for light 36 in the first wavelength range and the second plane 30 for light 38 in the second wavelength range fulfill the Scheimpflug condition. That is, the first plane 26, the second plane 30, a main plane 40 of the optics 14 and the sensor plane 34 of the image sensor 14 intersect in a line of intersection.

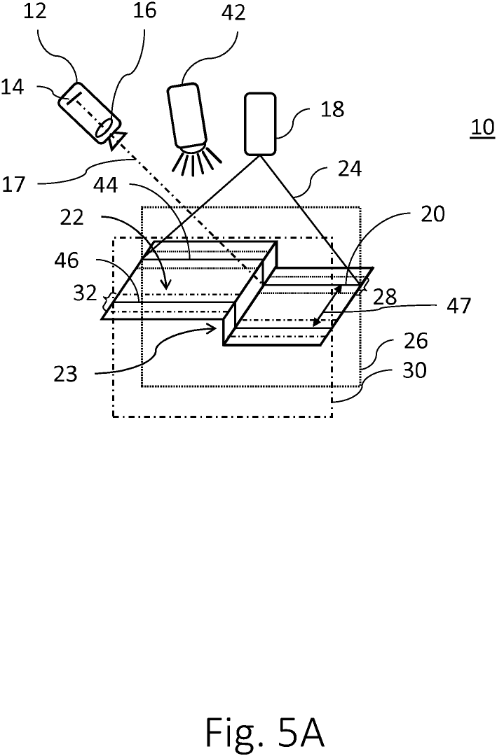

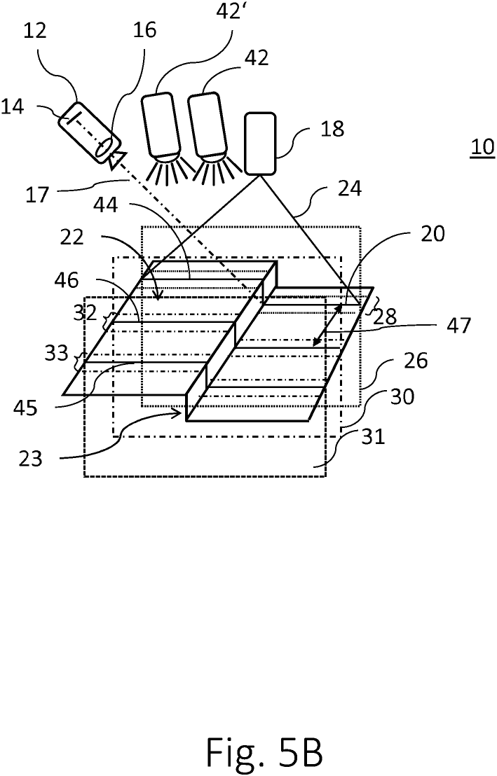

FIG. 5A shows a schematic view of an analysis device for analyzing a workpiece surface according to embodiments of the present invention.

The analysis device 10 is configured to carry out a method for analyzing a workpiece surface for a laser machining process according to embodiments of the present invention.

The analysis device 10 is configured to capture a two-dimensional image of the workpiece surface 22 and to evaluate the captured image in order to identify or analyze features of the workpiece surface. In particular, the analysis device 10 is configured to carry out a light section method or a light section triangulation method in order to detect a three-dimensional height profile of the workpiece surface 22. The analysis device 10 may detect, for example, a joint edge or step 23 of the workpiece surface 22 or a weld seam.

The analysis device 10 comprises a sensor device 12 with an image sensor 14 for capturing an image and optics 16 for imaging light on the image sensor 14 and may comprise an evaluation unit (not shown) for evaluating the image captured by image sensor 14. The image sensor 14 is a planar or two-dimensional optical sensor, for example a CMOS or CCD sensor. The optics 16 may be configured as a lens or an objective, but the invention is not limited thereto.

The analysis device 10 further comprises a light line unit 18 for generating a light line 20 of light of a first wavelength range on the workpiece surface 22. The light line unit 18 is configured to radiate a fan-shaped light beam 24 onto an area of the workpiece surface 22 in order to generate the light line 20 on the workpiece surface 22. In particular, the light line 20 may be oriented perpendicularly to a course of the joining edge or step 23. The light line unit 18 may be configured as a line laser. Accordingly, the light beam 24 may be a laser beam and the light line 20 may be a laser line, but the invention is not limited thereto. According to embodiments, the light line unit 18 is configured to generate a blue laser beam with a wavelength of approximately 400 nm to 500 nm. According to embodiments, the light line unit 18 is arranged in such a way that it can radiate the light beam 24 perpendicularly onto the workpiece surface 22.

The analysis device 10 further comprises an illumination unit 42 configured to generate light of a second wavelength range and to radiate it onto the area of the workpiece surface 22. According to embodiments, the illumination unit 42 is configured as a red LED lighting and configured to generate red light, e.g. with a wavelength of approximately 620 nm to 720 nm. The area of the workpiece surface 22 may be illuminated with light of a second wavelength range over a large area and/or non-directionally. An arrangement or orientation of the lighting unit 42 may be arbitrary as long as the area of the workpiece surface 22 is illuminated. The image sensor 14 is sensitive to both wavelength ranges.

The optics 16 has different refractive indices for light in the first wavelength range and light in the second wavelength range. The optics 16 may be referred to as an uncorrected optics. According to embodiments, an optical axis 17 of the optics 16 may lie in a plane that extends perpendicularly to the workpiece surface 22 and in parallel to the joint edge or step 23 (or through the joint edge or step 23).

A first plane 26 is defined by a light exit point of the light of the first wavelength range from the light line unit 18 and the light line 22. In other words, the first plane 26 is spanned by the planar fan-shaped light beam 24. The first plane 26, the optics 16 and a sensor plane of the image sensor 14 are arranged in the Scheimpflug arrangement or meet the Scheimpflug condition. As a result, all points of the first plane 26 are imaged sharply on the sensor plane of the image sensor 14 by the optics 16. The first plane 26 may also be referred to as the “triangulation plane”. Since the first plane 26 also includes the light line 20, the light of the light line 20 reflected by the workpiece surface 22 is also imaged sharply on the image sensor 14. The first plane 26 intersects the workpiece surface 22 in a first line of intersection 44. As a result, all points of the workpiece surface 22 on different planes intersecting the first plane 26 are imaged sharply. The first line of intersection 44 of the first plane 26 with the workpiece surface 22 corresponds to the light line 20 or coincides with the light line 20.

The first plane 26 is preferably arranged substantially perpendicular to the workpiece surface 22. In other words, an optical axis of the light line unit 18 may extend substantially perpendicularly to the workpiece surface 22. The optical axis 17 of the optics 16 may intersect the first plane 26 at an acute angle.

As previously described, the workpiece surface 22 is also illuminated by the illumination unit 42 with light in the second wavelength range. A second plane 30, for which the light of the second wavelength range is imaged sharply on the sensor plane of the image sensor 14 by the optics 16, differs from the first plane 26, as was explained with reference to FIG. 4. The second plane 30, the optics 16 and the sensor plane of the image sensor 14 are also arranged in a Scheimpflug arrangement or meet the Scheimpflug condition for light of the second wavelength range. The second plane 30 intersects the workpiece surface 22 at a second line of intersection 46. The second line of intersection 46 and the first line of intersection 44 are spaced from one another. The (shortest) distance between the two lines of intersection 44, 46 is referred to as an offset 47.

Moreover, a certain three-dimensional depth of focus range within which points are imaged sufficiently sharply by the optics 16 on the image sensor 14 in front of and behind the plane 26 and in front of and behind the second plane 30 in the direction of the optical axis 17 of the optics 16. In other words, a first depth of focus surrounds the first plane 26 and a second depth of focus surrounds the second plane 30. Since the first plane 26 intersects the workpiece surface, all points on planes intersecting the first plane 26 within the first depth of focus are imaged sharply on the image for reflected light of the first wavelength range. Since the second plane 30 intersects the workpiece surface, all points on planes intersecting the second plane 30 within the second depth of focus are imaged sharply on the image for reflected light of the second wavelength range. Accordingly, a first partial area 28 of the workpiece surface 22, which surrounds the line of intersection 44 of the first plane 26 with the workpiece surface 22, is imaged sufficiently sharply on the image sensor 14 for light of the first wavelength range, and a second partial area 32 of the workpiece surface 22, which surrounds the line of intersection 46 of the second plane 30 with the workpiece surface 22, is imaged sufficiently sharply on the image sensor 14 for light of the second wavelength range. The partial area 28 is in front of and behind the line of intersection 44 in the direction of the optical axis 17 of the optics 16. The partial area 32 is in front of and behind the line of intersection 46 in the direction of the optical axis 17 of the optics 16. Both partial areas 28, 32 are spaced apart from one another according to embodiments and do not intersect or overlap. Accordingly, the light line 20 of the first wavelength range is not in the second partial area 32 which is sharply imaged for light of the second wavelength range.

Of course, it is possible to use other central wavelengths that differ from one another or are spaced apart from one another for illumination. Here, central wavelength refers to the wavelength that is in the middle of a wavelength range. For this purpose, an illumination unit 42, 42′ may be provided for each illumination wavelength. In addition, an illumination unit 42 that radiates light in a large wavelength range, for example a broadband light source or white light source, and one or more filters that transmit a plurality of wavelengths or wavelength ranges that are spaced apart from one another may be provided. The filter is arranged in front of the image sensor 14, i.e. it may either be arranged on the illumination unit 42, or in front or behind the optics 16. When light from at least one further third wavelength range is used to illuminate, a further third plane 31 results which generates a third partial area 33 offset in parallel to the second partial area 32 on the workpiece surface. Many wavelengths, such as those produced by an illumination unit with a continuous spectrum, generate many such planes of intersection which intersect the workpiece surface in parallel to the second plane 30. Each wavelength generates a depth of focus range or partial area on the workpiece surface offset in parallel to the second partial area 32. In total, the surface area that is imaged sharply can be enlarged. This is shown as an example in FIG. 5B for illumination with light of a third wavelength range by a further illumination unit 42′, resulting in a third plane 31 with a third line of intersection 45 around which a third partial area 33 is arranged. For example, the second wavelength range may be 660±5 nm and the third wavelength range may be 720±5 nm. The first wavelength range may be 450±5 nm. The central wavelengths of the second, third, etc. wavelength ranges that are used to illuminate are preferably selected in such a way that the respective depth of focus ranges or partial areas adjoin one another.

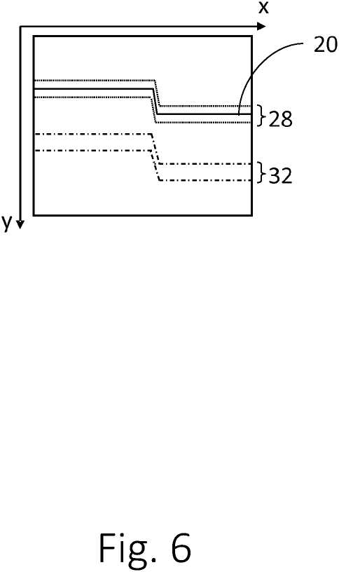

FIG. 6 shows, schematically and by way of example, an image captured by the analysis device according to the present invention. The image comprises a plurality of pixels (not shown) in a matrix arrangement which are arranged in columns along a first direction x and in rows along a second direction y. As shown in FIG. 6, the laser line 20 is imaged in the image captured by the image sensor 14. In addition, the first partial area 28 and the second partial area 32 of the workpiece surface 22, which are imaged sharply in the image, are marked. In the image, the two partial areas 28, 32 are also spaced apart from one another. Since the light line 20 is not located in the second partial area 32, the capture of the image of the workpiece surface in the second partial area 32 is not disturbed by the bright light line 20. As a result, the contrast for the second partial area 32 is increased in the captured image. In addition, the second partial area 32 is imaged sharply on the image sensor 14 for light of the second wavelength range.

Thus, the sharply imaged light line 20 may be extracted from the captured image and may be evaluated in order to carry out the light section method for detecting the three-dimensional height profile of the workpiece surface. Based on the offset 47 described above, the sharply imaged second partial area 32 for the light of the second wavelength range offset to the light line can be can be extracted from the image in order to obtain a sharp image, in particular a gray image, of the second partial area 32 of the workpiece surface 22.

The extraction of the image sensor or the image is optimized in such a way that the light line 20 is extracted and the second partial area 32 is extracted offset thereto or offset to the peak intensity of the light line 20. The second partial area 32 typically comprises between 20 and 100 rows in the image, depending on the imaging by the optics and the image sensor used. The points of the light line may be converted directly into distance values via calibration values.

According to embodiments, the analysis device 10 is arranged on a laser machining head for machining a workpiece by means of a laser beam. The analysis device may be attached to a housing of the laser machining head, for example.

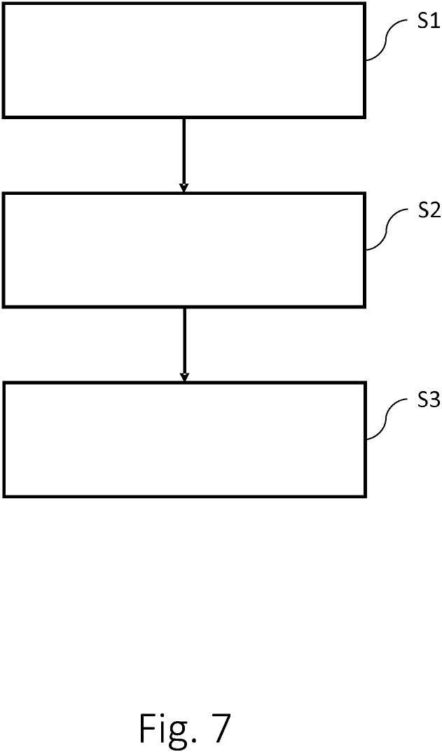

FIG. 7 shows a block diagram of a method for analyzing a workpiece surface for a laser machining process according to embodiments of the present invention. The method may be performed by the analyzing device 10 previously described with reference to FIGS. 5A, 5B and 6.

The method comprises the following steps: First, a light line 20 of light in a first wavelength range is radiated into an area of a workpiece surface 22 and the area of workpiece surface 22 is illuminated with light in a second wavelength range (S1). An image of the area of the workpiece surface 22 is then captured using a sensor device 12 (S2). The sensor device 12 comprises an image sensor 14 and optics 16 for imaging light on the image sensor 14, wherein the optics 16 has different refractive indices for the first and second wavelength ranges and a first plane 26 defined by the light line 20 and a light exit point of the light of the first wavelength range, the optics 16 and the image sensor 14 are arranged in a Scheimpflug arrangement. Thus, the image is captured based on light of the first wavelength range and the second wavelength range which is reflected by the area of the workpiece surface 22 and is imaged by the optics 16 on the image sensor 14. Next, the image is evaluated in order to analyze features of the work surface (S3).

The evaluation is based on the predetermined offset between the first plane 26 and a second plane 30 for which the light of the second wavelength range is sharply imaged by the optics 16 on the sensor plane of the image sensor 14. The specified offset may be a predetermined or known offset. The offset may be modeled, calculated or determined by measurement. The offset may be specified with respect to the workpiece surface or along an optical axis 17 of the optics 16 or the sensor device 12.

In the captured image, as previously described with reference to FIGS. 5A, 5B, 6, the first partial area 28 for light of the first wavelength range reflected by the workpiece surface 22 and the second partial area 32 for light of the first wavelength range reflected by the workpiece surface are sharply imaged. According to embodiments, evaluating the image comprises evaluating the first partial area 28. This may in particular comprise extracting brightness information contained in the image for the imaged first partial area 28 for light of the first wavelength range. In particular, this may comprise determining a position or shape of the imaged light line 22. Based thereon, a light section method may be carried out in order to determine, for example, the position and orientation of features of the workpiece surface, for example a joint edge, a joint gap or a weld seam. Evaluating the image may further comprise evaluating the imaged second partial area 32. This may in particular comprise extracting brightness information contained in the image for the imaged second partial area 32 for light of the second wavelength range. Based thereon, a sharp gray image of the second partial area 32 may be obtained. Based on the gray image, further features of the workpiece surface 22, in particular a weld seam, for example a roughness, a color and reflection properties, may be recognized and analyzed. The evaluation may be performed using known methods for image processing and analysis. Evaluating the image may comprise evaluating the captured image row-by-row and/or column-by-column. The evaluation may be carried out using known machine learning methods.

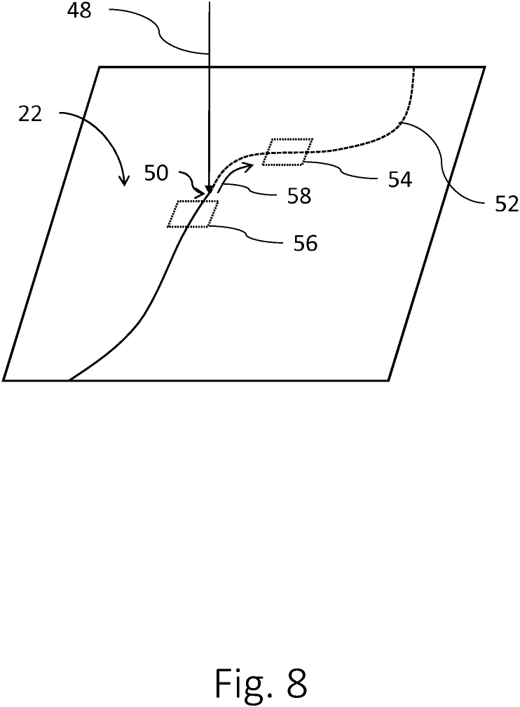

The method according to the invention may be part of a method for machining a workpiece by means of a laser beam, for example laser welding. As illustrated in FIG. 8, the method for machining a workpiece using a laser beam according to embodiments includes radiating a laser beam 48 onto a point 50 along a predetermined machining path 52 on the workpiece surface 22. For pre- and/or post-process monitoring, the method for machining the workpiece comprises the method for analyzing the workpiece surface 22 according to the invention. The method according to the invention may be carried out in advance 54 (pre-process) and/or in a wake 56 (post-process) of the point 50 with respect to the machining direction 58. In advance 54, for example, an edge offset, a joint gap and a joint edge may be recognized or detected. In the wake 56, a weld seam may be recognized or detected and analyzed and further features of the workpiece surface 22 or the weld seam may be detected.

According to embodiments, the method for analyzing a workpiece surface for a laser machining process may comprise moving the workpiece surface relative to the sensor device and repeating S1 to S3 described above. In other words, a plurality of images of the workpiece surface 22 may be captured one after the other. For this purpose, the respective second partial areas 32 extracted from the plurality of images may be combined to form a gray image of the workpiece surface 22. As a result, a sharp gray image of a larger area of the workpiece surface 22 can be obtained.

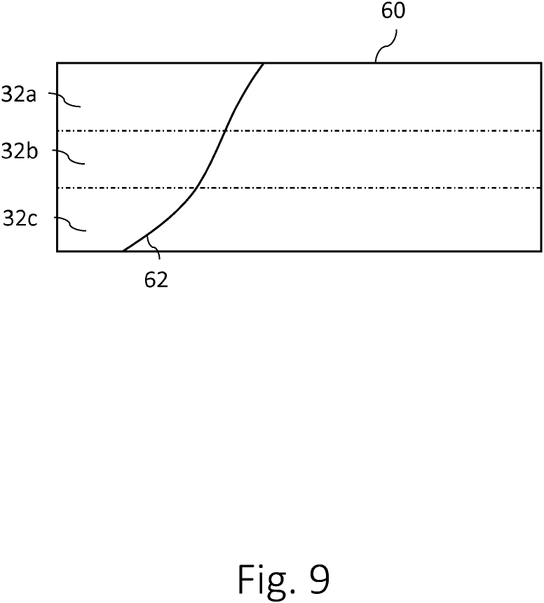

By way of example, such a composite gray image is illustrated in FIG. 9. The composite gray image 60 is based on three second partial areas 32a, 32b, 32c which were extracted from the respective captured images and combined to form the gray image 60. Since each of the second partial areas 32a, 32b, 32c was imaged sharply on the respective image, the composite gray image images a larger portion of the workpiece surface 22 sharply. The gray image 60 also shows a weld seam 62. The merging of the partial areas 32a, 32b, 32c to form the gray image 60 may include image processing, in particular a perspective or spatial transformation of the second partial areas 32a, 32b, 32c.

Correspondingly, the respective first partial areas 28 extracted from the plurality of images can be combined to form a three-dimensional height profile of a larger area of the workpiece surface 22.

The present invention is based on the idea that an optics with a longitudinal color error images the object planes differently for different wavelengths. In this case, the image plane is at a different distance from a main plane of the optics for each wavelength. This property may be used in a laser machining process in order to separate an area of a workpiece surface that is sharply imaged by the optics on an image sensor from an image of a light section line for a light section method. As a result, the advantage of a large measuring range in a Scheimpflug arrangement or image can be combined with the advantage of a large depth of focus in a gray image display. This means that the depth of focus, which severely restricted an evaluation area in the gray image, is extended to the measurement range of the Scheimpflug image.

### LIST OF REFERENCE SYMBOLS

10 analyzing device
12 sensor device
14 image sensor
16 optics
17 optical axis of the optics
18 light line unit
20 light line
22 workpiece surface
23 workpiece step
24 light beam
26 first plane
28 first partial area
30 second plane
32 second partial area
31 third plane
33 third partial area
34 sensor plane
36 light of a first wavelength range
38 light of a second wavelength range
40 main plane
42 illumination unit
44 first line of intersection
46 second line of intersection
45 third line of intersection
47 offset
48 laser beam
50 point on the machining path
52 machining path
54 advance
56 wake
58 machining direction
60 gray image
62 weld seam

1. A method for analyzing a workpiece surface for a laser machining process, comprising the steps of:
radiating a flat fan-shaped light beam of light of a first wavelength range to generate a light line on said workpiece surface and illuminating said workpiece surface with light of at least a second wavelength range;
capturing an image of said workpiece surface by means of a sensor device, which comprises an image sensor and an optical system for imaging light on said image sensor,
wherein said optics has different refractive indices for the first and second wavelength ranges, and wherein a first plane defined by the plane of the fan-shaped light beam, said optics and said image sensor are arranged in a Scheimpflug arrangement; and
evaluating the image to analyze features of said workpiece surface based on a predetermined offset on the workpiece surface between the first plane and a second plane for which the light of the second wavelength range from said optics is imaged on said image sensor.

2. The method according to claim 1, wherein the first plane is arranged perpendicularly to said workpiece surface and/or wherein an optical axis of said optics and/or an optical axis of said sensor device form an acute angle with the first plane.

3. The method according to claim 1, wherein the features of said workpiece surface include a weld seam or a joint edge and an optical axis of said sensor device and/or an optical axis of said optics lie in a plane which extends perpendicularly to said workpiece surface and in parallel to the weld seam or joint edge.

4. The method according to claim 1, wherein the first wavelength range comprises blue light, preferably light with a wavelength of 400 nm to 500 nm, particularly preferably 450 nm, and/or wherein the second wavelength range comprises red light, preferably light with a wavelength of 620 nm to 720 nm, particularly preferably 660 nm, and/or wherein a third wavelength range comprises light with a wavelength of 720 nm.

5. The method according to claim 1, wherein evaluating the image comprises:
evaluating intensity data of light of the first wavelength range for generating a height profile of the workpiece surface.

6. The method according to claim 1, wherein a partial area of said workpiece surface surrounds a line of intersection of the second plane with said workpiece surface, and wherein evaluating the image comprises:
evaluating intensity data of light of the second wavelength range in an area of the image corresponding to the partial area in order to obtain a gray image of the partial area.

7. The method according to claim 1, wherein said workpiece surface is further illuminated with light of at least a third wavelength range and said optics has different refractive indices for the first, the second and the third wavelength ranges, and wherein evaluating the image for analyzing features of said workpiece surface is also carried out based on a predetermined offset on the workpiece surface between the first plane and a third plane for which the light of the third wavelength range is imaged on said image sensor by said optics.

8. The method according to claim 1, wherein said workpiece surface is subsequently moved relative to said sensor device and the above steps are repeated.

9. A method for machining a workpiece using a laser beam, in particular laser welding or laser cutting, comprising:
radiating a laser beam onto a point along a machining path on a workpiece surface;
the method according to claim 1, wherein the light line is radiated onto said workpiece surface in advance and/or in the wake of the point.

10. An analysis device for analyzing a workpiece surface, comprising:
a sensor device with an image sensor for capturing an image and optics for imaging light on said image sensor, said optics having different refractive indices for a first wavelength range and at least one second wavelength range;
a light line unit for radiating a light line of a first wavelength range and an illumination unit for radiating light of at least one second wavelength range, and
an evaluation unit for evaluating the image captured by said image sensor, wherein said analysis device is configured to carry out the method for analyzing the workpiece surface according to claim 1.

11. The analysis device according to claim 10, wherein said optics comprises a lens, a lens group, a focusing lens, a focusing lens group, an objective and/or a zoom objective.

12. The analysis device according to claim 10, wherein said image sensor comprises a matrix image sensor, a two-dimensional optical sensor, a camera sensor, a CCD sensor, a CMOS sensor, and/or a photodiode array.

13. The analysis device according to claim 10, wherein said light line unit comprises an LED or an LED array.

14. A laser machining head for machining a workpiece by means of a laser beam, comprising an analysis device according to claim 10.

15. The laser machining head according to claim 14, wherein said laser machining head is configured to carry out a method for machining a workpiece using a laser beam, in particular laser welding or laser cutting, comprising:
radiating a laser beam onto a point along a machining path on a workpiece surface;
analyzing the workpiece surface for a laser machining process, comprising the steps of:
radiating a flat fan-shaped light beam of light of a first wavelength range to generate a light line on said workpiece surface and illuminating said workpiece surface with light of at least a second wavelength range;
capturing an image of said workpiece surface by means of a sensor device, which comprises an image sensor and an optical system for imaging light on said image sensor,
wherein said optics has different refractive indices for the first and second wavelength ranges, and wherein a first plane defined by the plane of the fan-shaped light beam, said optics and said image sensor are arranged in a Scheimpflug arrangement; and
evaluating the image to analyze features of said workpiece surface based on a predetermined offset on the workpiece surface between the first plane and a second plane for which the light of the second wavelength range from said optics is imaged on said image sensor;
wherein the light line is radiated onto said workpiece surface in advance and/or in the wake of the point.
